(19) United States
(12) Patent Application Publication
(10) Pub. No.: US 2007/0153351 A1
(43) Pub. Date: Jul. 5, 2007

(54) Micro optical scanner capable of measuring operating frequency of micro mirror

(75) Inventors: Sung-hoon Choa, Seoul (KR); Jong-hwa Won, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/450,272

(22) Filed: Jun. 12, 2006

(30) Foreign Application Priority Data
Dec. 30, 2005 (KR) 10-2005-0135843

(51) Int. Cl. G02B 26/08

(52) U.S. Cl. 359/224

(57) ABSTRACT

A micro optical scanner, which is capable of measuring the operating frequency of a micro mirror, includes: a substrate; the micro mirror which is integrally formed with the substrate and rotates to scan incident light; a package block sealing the substrate and the micro mirror and including a transparent window in an upper portion thereof; and at least one photo detector which detects reflected light from the transparent window from the light scanned by the micro mirror.

### CROSS-REFERENCE TO RELATED PATENT APPLICATION

This application claims priority from Korean Patent Application No. 10-2005-0135843, filed on Dec. 30, 2005, in the Korean Intellectual Property Office, the disclosure of which is incorporated herein in its entirety by reference.

### BACKGROUND OF THE INVENTION

1. Field of the Invention

The present invention relates to a micro optical scanner having a high speed driving micro mirror and, more particularly, to a micro optical scanner capable of measuring an operating frequency of a micro mirror.

2. Description of the Related Art

A micro actuator formed using a micro-electro-mechanical system (MEMS) technique generally includes a vertical comb-type electrode structure in which moving comb-electrodes and static comb-electrodes are respectively formed on upper and lower portions of a silicon-on-insulator (SOI) substrate.

FIG. 1 is a perspective view of a micro actuator 10 having a conventional vertical comb-type electrode structure. FIG. 2 is a cross-sectional view of the micro actuator of FIG. 1. Referring to FIGS. 1 and 2, in the conventional micro actuator 10, an upper silicon substrate 14 having moving comb-electrodes 17 is stacked on a lower silicon substrate 11 having static comb-electrodes 12. An insulation layer 13, for example, an oxide layer, is interposed between the lower silicon substrate 11 and the upper silicon substrate 14. The moving comb-electrodes 17 are vertically aligned on opposite sides of a driving plate 15 connected to the upper silicon substrate 14 through a spring 16. The static comb-electrodes 12 are formed on the lower silicon substrate 11 and alternate with respect to the moving comb-electrodes 17. When voltages are applied to the moving comb-electrodes 17 and the static comb-electrodes 12, the driving plate 15 linearly moves in a vertical direction or rotates due to an electrostatic force generated between the moving comb-electrodes 17 and the static comb-electrodes 12. In FIG. 1, the driving plate 15 rotates only in one direction for convenience of explanation. However, the driving plate 15 can be manufactured to rotate in two directions. Although not illustrated in FIGS. 1 and 2, the micro actuator may further include a package block sealing the driving plate 15.

When the driving plate 15 is formed as a micro mirror, the micro actuator can be used as, for example, a micro optical scanner which rapidly scans an image onto a screen in a laser TV. When the micro actuator is used as the micro optical scanner, the micro mirror must rapidly operate to rapidly scan an image onto a large screen of a laser TV. In general, the operating frequency of the micro mirror is determined by the frequency of current supplied to the moving comb-electrodes 17 and the static comb-electrodes 12. In particular, to effectively and rapidly operate the micro mirror, a current is supplied in response to the inherent resonant frequency of the micro mirror which is determined by the structure thereof.

However, due to the manufacturing tolerance of the MEMS, the inherent resonant frequencies of the micro mirrors are different. Thus, although a current having the same magnitude and frequency is supplied, the operating frequencies of the micro mirrors are not equal. Accordingly, it is very important to accurately measure the resonant frequency or operating frequency of the micro mirror. When the resonant frequency or operating frequency of the micro mirror is accurately known, the operating frequency of the micro mirror can be adjusted to be a desired value using, for example, a feedback control method.

However, a method of accurately measuring the resonant frequency or operating frequency of the micro mirror using a simple method has not been disclosed. In U.S. Pat. No. 6,593,677, a position sensor, a capacitance sensor, a piezoelectric sensor, and an optical sensor are suggested as an apparatus for detecting the operating frequency of the micro mirror, but a method of detecting the operating frequency of the micro mirror using these sensors is not disclosed. In addition, a plurality of additional optical fibers are employed as a light detecting member, and thus manufacturing costs increase and the plurality of optical fibers must be arranged on a micro optical scanner.

### SUMMARY OF THE INVENTION

The present invention provides a micro optical scanner capable of measuring an operating frequency of a micro mirror using a simple and inexpensive method.

According to an aspect of the present invention, there is provided a micro optical scanner including: a substrate; a micro mirror which is integrally formed with the substrate and rotates to scan incident light; a package block sealing the substrate and the micro mirror and comprising a transparent window in an upper portion thereof; and at least one photo detector which detects light reflected by the transparent window among the light scanned by the micro mirror.

The at least one photo detector may be integrally formed with the substrate.

The at least one photo detector may be formed on the substrate using a complementary metal-oxide semiconductor (CMOS) manufacturing process.

The micro mirror may have first and second scanning directions perpendicular to each other, and the at least one photo detector may include a first photo detector measuring a first operating frequency along the first scanning direction and a second photo detector measuring a second operating frequency along the second scanning direction.

The first photo detector and the second photo detector may be respectively disposed on two adjacent sides of the substrate, which are perpendicular to each other.

The operating frequency of the micro mirror may be measured from a light detecting cycle of the photo detector.

At least the transparent window may be inclined in the upper package block.

A light absorbing layer may be formed on an inner surface of the upper package block at a region other than the transparent window, thereby to prevent the scanned light from being reflected.

The substrate may include a plurality of vertical static comb-electrodes, the micro mirror may include a plurality of vertical moving comb-electrodes, and the plurality of static comb-electrodes may be arranged to alternate with respect to the plurality of moving comb-electrodes.

The substrate may be a silicon-on-insulator (SOI) substrate.

### BRIEF DESCRIPTION OF THE DRAWINGS

The above and other features and advantages of the present invention will become more apparent by describing in detail exemplary embodiments thereof with reference to the attached drawings, in which:

FIG. 1 is a perspective view of a micro actuator having a conventional vertical comb-type electrode structure;

FIG. 2 is a cross-sectional view of the micro actuator of FIG. 1;

FIG. 3 is a cross-sectional view of a micro optical scanner capable of measuring an operating frequency of a micro mirror, according to an exemplary embodiment of the present invention;

FIG. 4 is a cross-sectional view of a micro optical scanner capable of measuring an operating frequency of a micro mirror, according to another exemplary embodiment of the present invention; and

FIG. 5 is a perspective view of a micro optical scanner capable of measuring an operating frequency of a micro mirror, according to a further exemplary embodiment of the present invention.

### DETAILED DESCRIPTION OF ILLUSTRATIVE, NON-LIMITING EMBODIMENTS OF THE INVENTION

Hereinafter, the present invention will be described more fully with reference to the accompanying drawings, in which exemplary embodiments of the invention are shown.

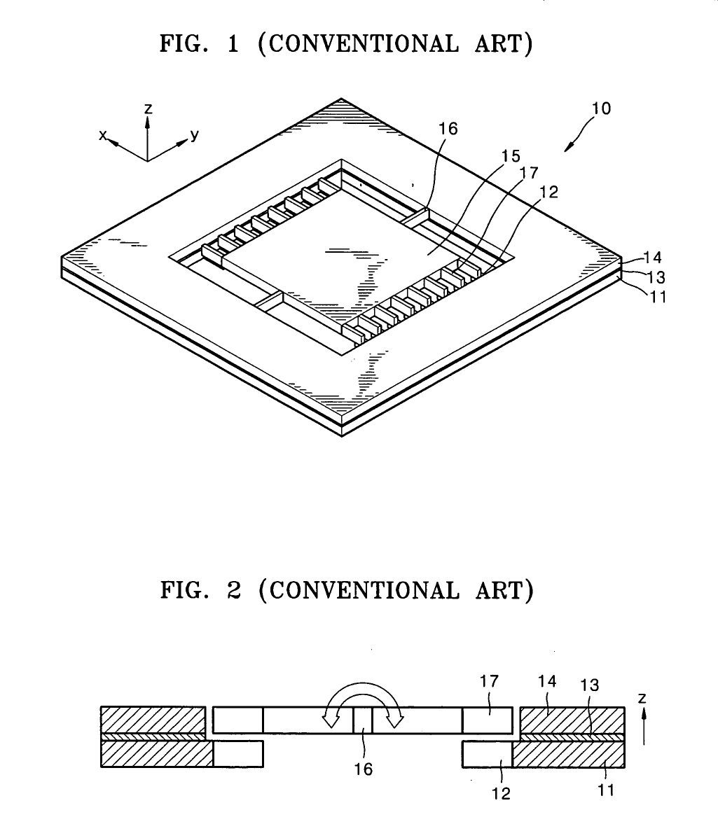

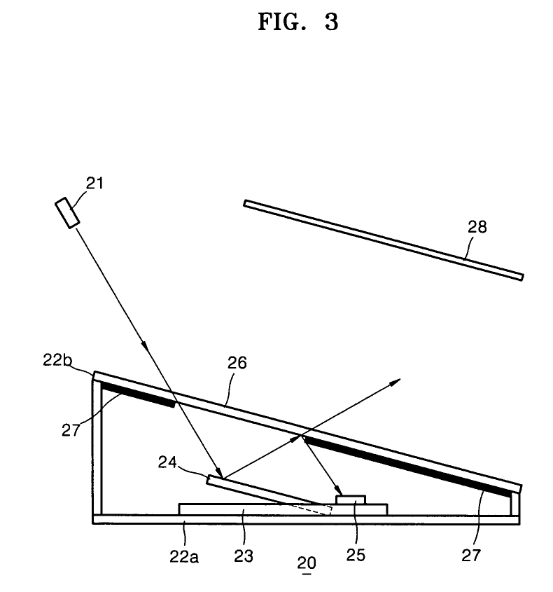

FIG. 3 is a cross-sectional view of a micro optical scanner 20 capable of measuring an operating frequency of a micro mirror 24, according to an exemplary embodiment of the present invention. Referring to FIG. 3, the micro optical scanner 20 includes a silicon-on-insulator (SOI) substrate 23 with which the micro mirror 24 is integrally formed, lower and upper package blocks 22a and 22b sealing the micro mirror 24 and the SOI substrate 23. The micro mirror 24 and the SOI substrate 23 are provided using a micro-electro-mechanical system (MEMS) technique, and have a commonly known vertical comb-type electrode structure including moving comb-electrodes and static comb-electrodes. That is, as described in FIG. 1, a plurality of moving comb-electrodes are vertically formed on both sides of the micro mirror 24. The plurality of static comb-electrodes are vertically formed on the SOI substrate 23 to alternate with respect to the plurality of moving comb-electrodes.

In addition, a photo detector 25 detecting light reflected from the micro mirror 24 is formed on the SOI substrate 23. The photo detector 25 may be integrally formed with the SOI substrate 23 using a complementary metal-oxide semiconductor (CMOS) manufacturing process. That is, a process of forming the photo detector 25 can be further added to processes in which the SOI substrate 23 is etched to form the micro mirror 24 in the SOI substrate 23. However, a separate light detecting semiconductor device, for example, a photo diode may be installed on the SOI substrate 23 as a photo detector 25. When the separate light detecting semiconductor device is installed, the photo detector 25 does not necessarily have to be formed on the SOI substrate 23. For example, the photo detector 25 may be formed on the lower package block 22a.

Since the micro mirror 24 has a size of less than several mm (for example, from about 0.5 mm to approximately 5 mm) according to an exemplary embodiment of the present invention, the micro mirror 24 is very sensitive to the external environment. Accordingly, to maintain the performance of the optical scanner 20 and protect it from the external environment, the micro mirror 24 and the SOI substrate 23 are hermetically sealed using the lower and upper package blocks 22a and 22b. For example, the SOI substrate 23 is bonded to the lower package block 22a and the upper package block 22b is adhered to the lower package block 22a to seal the SOI substrate 23. The upper package block 22b includes a transparent window 26 through which light emitted from a light source 21 is incident to the micro mirror 24. In addition, a light absorbing layer 27 may be formed on the inner surface of the upper package block 22b except for the transparent window 26 to prevent light from being reflected from or penetrating into the outside of the transparent window 26. For example, the upper package block 22b may be formed of a glass substrate which the light absorbing layer 27 is coated onto outside of the transparent window 26. Meanwhile, when some of the light emitted from the light source 21 cannot be transmitted through the transparent window 26, but is reflected toward the screen 28, images formed on the screen 28 may be distorted because of light interference. To prevent the light interference, the upper package block 22b may be inclined, as illustrated in FIG. 3.

In the micro optical scanner 20 of the present embodiment, the method of measuring the operating frequency of the micro mirror 24 will be described.

The light emitted from the light source 21, for example, a laser diode, is transmitted through the transparent window 26 of the upper package block 22b, is reflected from the micro mirror 24, is transmitted again through the transparent window 26, and then reaches the screen 28. When voltages are applied to the moving comb-electrodes formed on the micro mirror 24 and the static comb-electrodes formed on the SOI substrate 23, the micro mirror 24 rotates due to the electrostatic force between the moving comb-electrodes and the static comb-electrodes. Accordingly, the light emitted from the light source 21 is reflected from the micro mirror 24 to scan the screen 28 from the left side to the right side or vice versa due to the rotation of the micro mirror 24.

Not all of the light reflected from the micro mirror 24 is transmitted through the transparent window 26, and some of the light is reflected from the transparent window 26 back inside the micro optical scanner 20. The light reflected from the transparent window 26 is irradiated along a certain pathway with the same period of the micro mirror 24 in the micro optical scanner 20. The photo detector 25 is disposed on the pathway of the reflected light in the micro optical scanner 20, as illustrated in FIG. 3. In FIG. 3, the photo detector 25 is disposed on the SOI substrate 23, but can be disposed on the lower package block 22a. Accordingly, the period of the light detection in the photo detector 25 is measured from the output of the photo detector 25 by a measuring instrument such as, for example, an oscilloscope, and thus the operating frequency of the micro mirror 24 (which is a reciprocal of the period of the light detection) can be accurately calculated.

According to the present embodiment, the operating frequency of the micro mirror 24 can be simply calculated without an additional light source or optical apparatus apart from the light source 21. In addition, the photo detector 25 can be integrally formed with the SOI substrate 23 where the micro mirror 24 is formed using, for example, a CMOS manufacturing process, and thus the photo detector 25 and the micro mirror 24 can be simultaneously formed. According to the exemplary embodiment of the present invention, the cost of manufacturing the micro optical scanner 20 is reduced.

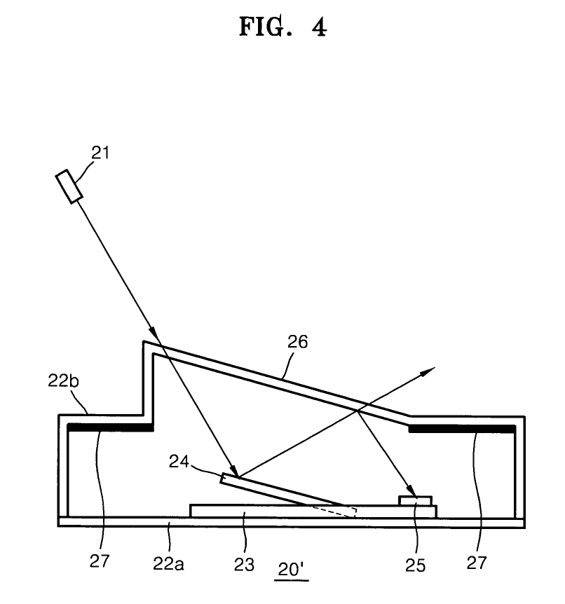

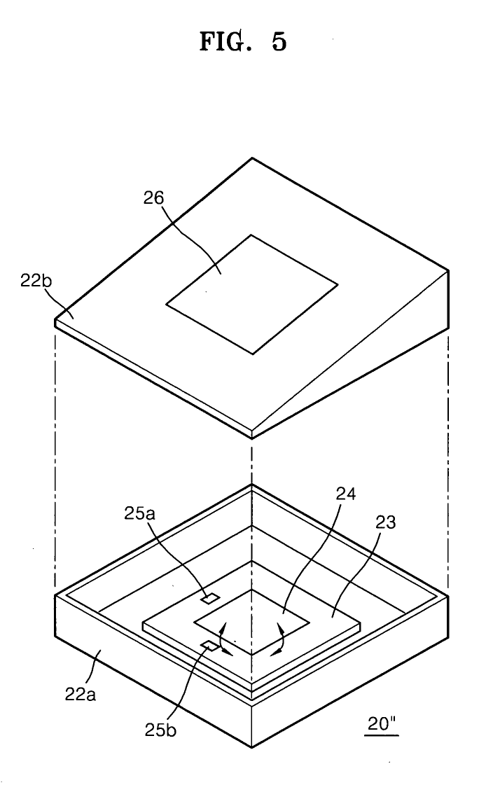

FIG. 4 is a cross-sectional view of a micro optical scanner 20′ capable of measuring an operating frequency of a micro mirror 24, according to another exemplary embodiment of the present invention. Referring to FIG. 4, in the micro optical scanner 20′, only a transparent window 26 is inclined in an upper package block 22b, and the other portion of the upper package block 22b is horizontally formed. Accordingly, the size of the micro optical scanner 20′ can be reduced. The micro optical scanner 20′ of FIG. 4 has a similar structure to the micro optical scanner 20 of FIG. 3 except for the shape of the upper package block 22b.

FIG. 5 is an exploded perspective view of a micro optical scanner 20″ capable of measuring an operating frequency of a micro mirror 24, according to a further embodiment of the present invention. Referring to FIG. 5, the SOI substrate 23 is bonded to a lower package block 22a, and an upper package block 22b is adhered to the lower package block 22a to seal the SOI substrate 23 and the micro mirror 24.

The micro mirror 24 may rotate in a first direction and a second direction, which is perpendicular to the first direction. To accurately form an image on a screen 28, the screen 28 should be two-dimensionally scanned. Accordingly, the operating frequency of the micro mirror 24 is separately measured corresponding to the scanning directions. The micro optical scanner 20 according to the current embodiment of the present invention may include photo detectors 25a and 25b for detecting lights in different scanning directions, as illustrated in FIG. 5. For example, the first photo detector 25a may measure the operating frequency of the micro mirror 24 when scanning in the first direction, and the second photo detector 25a may measure the operating frequency of the micro mirror 24 when scanning in the second direction.

As illustrated in FIG. 5, the first photo detector 25a and the second photo detector 25b may be respectively disposed on two adjacent sides of the SOI substrate 23, which are perpendicular to each other.

According to the present invention, the operating frequency of the micro mirror can be simply calculated without an additional light source or optical apparatus besides the light source providing an image on the screen.

In addition, the photo detectors can be integrally formed with the SOI substrate where the micro mirror is formed. Accordingly, the photo detectors can be simultaneously manufactured with the micro mirror. According to the present invention, the cost of manufacturing a micro optical scanner is reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A micro optical scanner comprising:
a substrate;
a micro mirror which is integrally formed with the substrate and rotates to scan incident light;
a package block sealing the substrate and the micro mirror and comprising a transparent window in an upper portion thereof; and
at least one photo detector which detects light reflected by the transparent window among the light scanned by the micro mirror.

2. The micro optical scanner of claim 1, wherein the at least one photo detector is integrally formed with the substrate.

3. The micro optical scanner of claim 2, wherein the at least one photo detector is formed on the substrate using a complementary metal-oxide semiconductor (CMOS) manufacturing process.

4. The micro optical scanner of claim 1, wherein the micro mirror has first and second scanning directions perpendicular to each other, and the at least one photo detector comprises a first photo detector measuring a first operating frequency along the first scanning direction and a second photo detector measuring a second operating frequency along the second scanning direction.

5. The micro optical scanner of claim 4, wherein the first photo detector and the second photo detector are respectively disposed on two adjacent sides of the substrate, which are perpendicular to each other.

6. The micro optical scanner of claim 1, wherein the operating frequency of the micro mirror is measured from a light detecting cycle of the photo detector.

7. The micro optical scanner of claim 1, wherein at least the transparent window is inclined in the upper package block.

8. The micro optical scanner of claim 7, wherein a light absorbing layer is formed on an inner surface of the upper package block at a region other than the transparent window, thereby to prevent the scanned light from being reflected.

9. The micro optical scanner of claim 1, wherein the substrate comprises a plurality of vertical static comb-electrodes, the micro mirror comprises a plurality of vertical moving comb-electrodes, and the plurality of static comb-electrodes are arranged to alternate with respect to the plurality of moving comb-electrodes.

10. The micro optical scanner of claim 1, wherein the substrate is a silicon-on-insulator (SOI) substrate.
